(19) United States
(12) Patent Application Publication
(10) Pub. No.: US 2026/0254903 A1
(43) Pub. Date: Aug. 27, 2026

(54) SHEET FEEDING DEVICE

(71) Applicant: BROTHER KOGYO KABUSHIKI KAISHA, Nagoya (JP)

(72) Inventors: Kimio TAKEUCHI, Konan (JP); Yoshihiro OKAMOTO, Komaki (JP)

(73) Assignee: BROTHER KOGYO KABUSHIKI KAISHA, Nagoya (JP)

(21) Appl. No.: 19/546,604

(22) Filed: Feb. 23, 2026

(30) Foreign Application Priority Data
Feb. 25, 2025 (JP) 2025-028130

(51) Int. Cl. H04N 1/00

(52) U.S. Cl. CPC H04N 1/00588; H04N 1/00602; H04N 1/00615; H04N 1/00687; H04N 1/00745; H04N 1/00782

(57) ABSTRACT

A sheet feeding device includes a supply tray having a support surface, a feed roller configured to feed a sheet in a feeding direction orthogonal to a widthwise direction of the support surface, and a shutter swingable between a regulation position and a retracted position. When in the regulation position, the shutter regulates a leading edge of a sheet inserted along the support surface, and when in the retracted position, the shutter does not interfere with advancement of the sheet. The shutter includes a plurality of first regulation surfaces arranged in an up-down direction and facing upstream in the feeding direction, and at least one second regulation surface located between adjacent first regulation surfaces and facing downward. A lower first regulation surface is positioned downstream of an upper first regulation surface, and the second regulation surface connects ends of the adjacent first regulation surfaces.

### REFERENCE TO RELATED APPLICATIONS

This application claims priority from Japanese Patent Application No. 2025-028130 filed on February 25, 2025. The entire content of the priority application is incorporated herein by reference.

### BACKGROUND ART

The present disclosure relates to a sheet feeding device.

Conventionally, a sheet feeding device used as an automatic sheet feeder for an image scanner and/or a printer is known. Such a sheet feeding device generally includes a sheet supply tray on which sheets are placed, and the sheet supply tray is provided with a support surface that supports the sheets. A pickup roller is provided to feed the sheets supported on the support surface in a feeding direction. In addition, a stopper is provided that is swingable between a sheet abutment position, at which a leading edge of an inserted sheet is regulated, and a retracted position, at which the stopper is retracted from a sheet fed by the pickup roller so as not to interfere with sheet feeding. In the sheet abutment position, the stopper is configured to align the leading edges of sheets inserted along the support surface, whereas in the retracted position, the stopper allows the fed sheet to pass therethrough.

### SUMMARY

The stopper has a regulation surface. The regulation surface is a flat surface which, when the stopper is in the sheet abutment position, faces upstream in the feeding direction and extends in a vertical direction, and is configured to be capable of contacting a leading edge of an inserted sheet. With such a regulation surface, the stopper aligns the leading edges of sheets when the stopper is in the sheet abutment position.

However, in the above-described conventional sheet feeding device, when a sheet whose leading edge is curled upward is inserted, the leading edge of the sheet tends to ride up when it comes into contact with the regulation surface of the stopper. As a result, it may become difficult for the sheet feeding device to properly align the leading edges of sheets whose leading edges are curled upward.

The present disclosure has been made in view of the above circumstances. According to aspects of the present disclosure, a sheet feeding device is provided that is capable of reliably aligning leading edges of sheets even when sheets having an upwardly curled leading edge are inserted along a support surface.

According to aspects of the present disclosure, there is provided a sheet feeding device including a supply tray having a support surface configured to support a sheet, a feed roller configured to feed the sheet supported on the support surface in a feeding direction orthogonal to a widthwise direction of the support surface, and a shutter configured to swing between a regulation position and a retracted position. When located at the regulation position, the shutter regulates a leading edge of a sheet inserted along the support surface, and when located at the retracted position, the shutter does not interfere with advancement of the sheet. The shutter has, when located at the regulation position, a plurality of first regulation surfaces and at least one second regulation surface that are capable of coming into contact with the leading edge of the sheet inserted along the support surface. Each of the first regulation surfaces is arranged in an up-down direction and faces upstream in the feeding direction, and the second regulation surface is located between the first regulation surfaces and faces downward.

In the sheet feeding device described above, when two first regulation surfaces are adjacent to each other in the up-down direction, an upper one of the two first regulation surfaces is defined as a first surface and the other is defined as a second surface. An entirety of the second surface is located downstream of the first surface in the feeding direction, and the second regulation surface located between the first surface and the second surface is connected to a lower end of the first surface and an upper end of the second surface. This positional relationship means that the first regulation surfaces and the second regulation surfaces form a stepwise inclined structure that extends so as to be progressively shifted downstream in the feeding direction as the structure approaches the support surface.

With this configuration, each of the first regulation surfaces can reliably regulate a leading edge of a sheet by guiding the leading edge downward toward the support surface, regardless of whether the leading edge of the sheet inserted along the support surface is curled upward.

In addition, when a sheet having a leading edge curled upward is inserted along the support surface, the second regulation surface prevents the leading edge from moving upward by blocking upward displacement of the leading edge along the stepwise inclined structure.

Therefore, the sheet feeding device of the present disclosure can reliably align leading edges of sheets even when sheets having leading edges curled upward are inserted along the support surface.

### BRIEF DESCRIPTION OF THE DRAWINGS

FIG. 1 is a perspective view of an image reading apparatus according to a present embodiment.

FIG. 2 is a schematic partial cross-sectional view of the image reading apparatus according to the present embodiment.

FIG. 3 is a partial perspective view of a cover, illustrating a state in which a left-end upper cover in a closed position is not shown, and a holder, a shutter, and the like mounted on the left-end upper cover are shown.

FIG. 4 is a partial perspective view of the cover, illustrating a state in which the left-end upper cover, the holder, the shutter, and the like are removed.

FIG. 5 is a schematic partial cross-sectional view illustrating a shutter whose swinging movement from a regulating position to a retracted position is restricted by a lock member in a locked position.

FIG. 6 is a schematic partial cross-sectional view illustrating a shutter whose swinging movement from the regulating position to the retracted position is permitted by a lock member in an unlocked position.

FIG. 7 is a side view of the shutter.

FIG. 8 is a perspective view of the shutter.

FIG. 9 is a schematic partial cross-sectional view illustrating a state in which a contact surface of an actuator is not in contact with a leading edge of a sheet inserted along a support surface.

FIG. 10 is a schematic partial cross-sectional view illustrating a state after the contact surface of the actuator has come into contact with the leading edge of the sheet inserted along the support surface.

### DESCRIPTION

Hereinafter, an embodiment in which the present disclosure is implemented will be described with reference to the accompanying drawings.

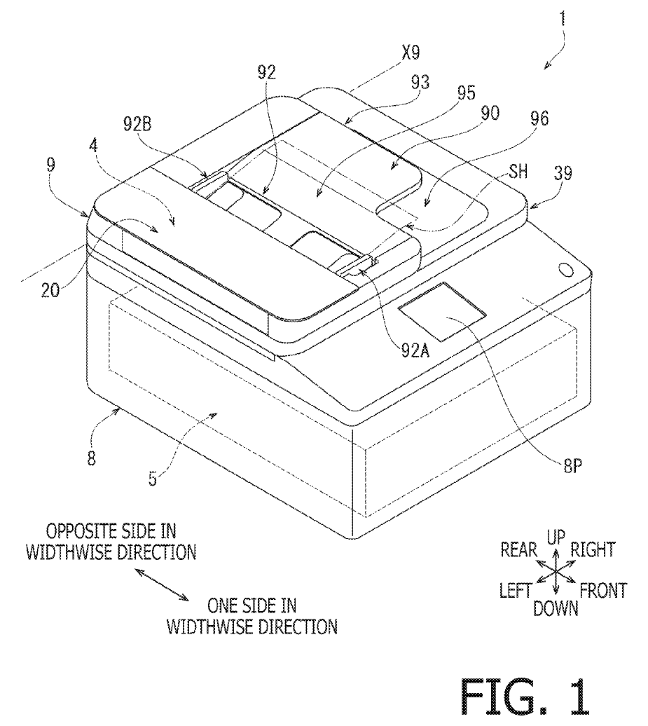

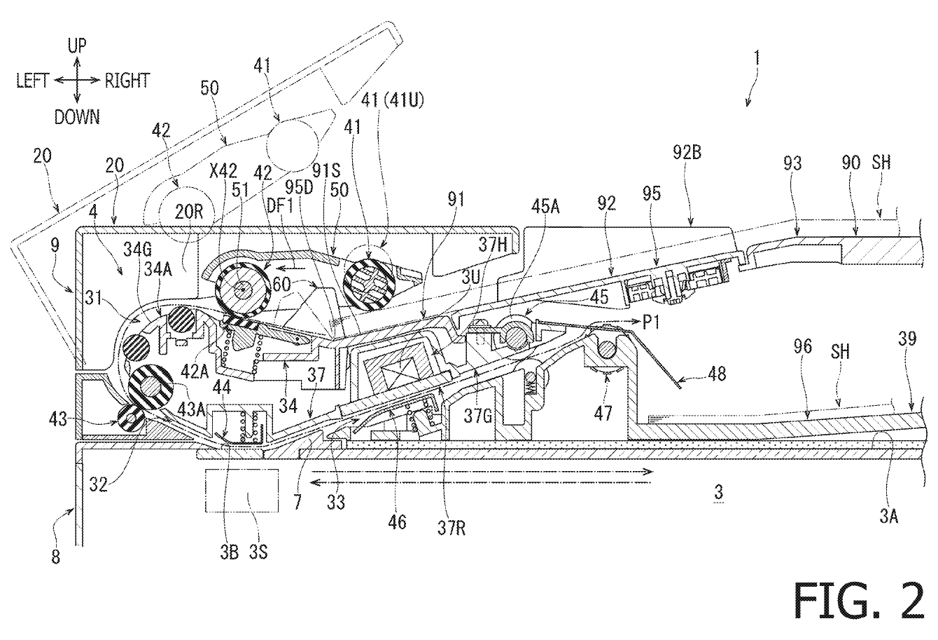

FIG. 1 shows an image reading apparatus 1, in which a sheet feeding device according to an embodiment of the present disclosure is implemented. In FIG. 1, a side on which an operation panel 8P is provided is defined as a front side of the image reading apparatus 1, and a left-right direction is defined such that a side located on the left when facing the operation panel 8P is a left side of the image reading apparatus 1. In FIG. 2 and the subsequent figures, front-rear, left-right, and up-down directions correspond to the directions defined in FIG. 1.

As shown in FIG. 1, the image reading apparatus 1 includes a main body 8 and a cover 9. The main body 8 has a generally flat, box-shaped configuration. The operation panel 8P, such as a touch panel, is located on the front surface of the main body 8. A lower portion of the main body 8 accommodates an image forming unit 5. The image forming unit 5 is a hardware component configured to form an image on a sheet by an inkjet method, a laser method, or another suitable printing method.

As shown in FIG. 2, an upper portion of the main body 8 accommodates an image reading unit 3. The image reading unit 3 is a hardware component including a document supporting surface 3A (hereinafter, also referred to as a "supporting surface"), a reading surface 3B, a first reading sensor 3S, and a well-known scanning mechanism.

The document supporting surface 3A is an upper surface of a large-area platen glass located on an upper surface of the main body 8. The reading surface 3B is an upper surface of a platen glass that is located to the left of the document supporting surface 3A on the upper surface of the main body 8 and extends in an elongated shape in a front-rear direction, which is a direction perpendicular to a plane of FIG. 2. A scoop guide 7 is located between the document supporting surface 3A and the reading surface 3B on the upper surface of the main body 8. The scoop guide 7 protrudes upward and extends in an elongated shape in the front-rear direction.

The document supporting surface 3A is configured to support a document that is a target of image reading. The document may be a sheet such as paper or an OHP sheet, or may be a book or the like. The reading surface 3B and the scoop guide 7 are used when a conveying unit 4 operates, the conveying unit 4 being a hardware component configured to convey a sheet, as will be described later.

The first reading sensor 3S is a well-known image reading sensor using a contact image sensor (CIS), a charge coupled device (CCD), or the like, and extends in an elongated shape in the front-rear direction. The first reading sensor 3S is positioned below the document supporting surface 3A or below the reading surface 3B, depending on an operating state of the apparatus, as will be described below.

When the image reading unit 3 reads an image of a document supported on the document supporting surface 3A, the first reading sensor 3S is moved, by operation of a scanning mechanism (not shown), rightward (e.g., in FIG. 2) from a position below a left end edge of the document supporting surface 3A, that is, in a sub-scanning direction, while reading the image of the document line by line in the front-rear direction, that is, in a main scanning direction. The first reading sensor 3S finishes reading the image when it reaches a position below a right end edge of the document supporting surface 3A, and then returns to a standby position by operation of the scanning mechanism (not shown). The standby position may be, for example, a position below the left end edge of the document supporting surface 3A (i.e., the left-end of the sub-scanning direction).

When the conveying unit 4 operates to convey a sheet for image reading, the first reading sensor 3S is moved, by operation of the scanning mechanism (not shown), to a stationary reading position below the reading surface 3B and remains stationary there.

As shown in FIG. 1, a cover 9 is located above the main body 8. A rear end of the cover 9 is connected to a rear end of the main body 8 via a hinge (not shown), allowing the cover 9 to swing about a swing axis X9 extending in a left-right direction.

As shown in FIG. 2, the cover 9 has a base member 39, and a lower surface of the base member 39 defines a bottom surface of the cover 9. The bottom surface of the cover 9 is configured to be large enough to cover the document supporting surface 3A and the reading surface 3B, and to cover a document placed on the document supporting surface 3A.

The base member 39 is an integrally molded product made of a resin material. In the present embodiment, the base member 39 is manufactured by injection molding of a thermoplastic resin or by another suitable thermoplastic resin molding method.

When the user swings the cover 9 upward and rearward (that is, counterclockwise as viewed in FIG. 2) about the swing axis X9, the supporting surface 3A is uncovered. In this state, the user can place the document on the supporting surface 3A or remove the document from the supporting surface 3A.

As shown in FIGS. 1 and 2, the cover 9 includes a supply tray 90 and a discharge tray 96. The supply tray 90 and the discharge tray 96 are located in a right-side portion of the cover 9.

As shown in FIGS. 1 and 2, the cover 9 includes the supply tray 90 and a discharge tray 96. The supply tray 90 and the discharge tray 96 are provided in a right-side portion of the cover 9.

As shown in FIG. 2, the supply tray 90 is located above the discharge tray 96. The supply tray 90 has a support surface 95 configured to support sheets SH, whose images are to be read, in a stacked state.

In the present embodiment, an object whose image is to be read while being placed on the supporting surface 3A is referred to as a "document," and an object that is supported on the support surface 95 and whose image is read while being conveyed by the conveying unit 4 is referred to as a "sheet SH." A document and a sheet SH may be substantially the same in nature so long as the document is in the form of a sheet.

The support surface 95 extends in a front-rear direction while gently sloping downward toward the left. A widthwise direction of the support surface 95 is the front-rear direction. In the present embodiment, one side and its opposite side in the widthwise direction correspond to a front side and a rear side, respectively.

A feeding direction DF1 in which the sheets SH supported on the support surface 95 are fed is a direction in which the sheets SH move leftward and is orthogonal to the widthwise direction.

A downstream end 95D of the support surface 95 in the feeding direction DF1 is located between a left side surface of the cover 9 and a central portion of the cover 9 in the left-right direction.

The cover 9 includes a lower chute 37, an upper chute 34, and a left-end upper cover 20. The lower chute 37 is located above a left-side portion of the base member 39. The upper chute 34 is located above the lower chute 37 and below the left-end upper cover 20.

In the present embodiment, each of the lower chute 37, the upper chute 34, and the left-end upper cover 20 is an integrally molded product made of a resin material, and is manufactured by injection molding of a thermoplastic resin or by another suitable molding method using a thermoplastic resin.

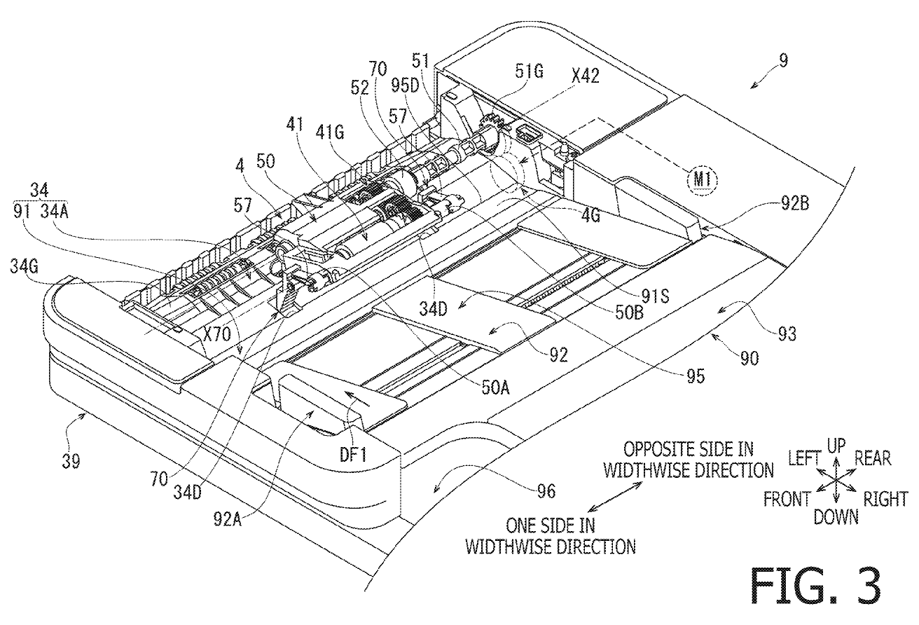

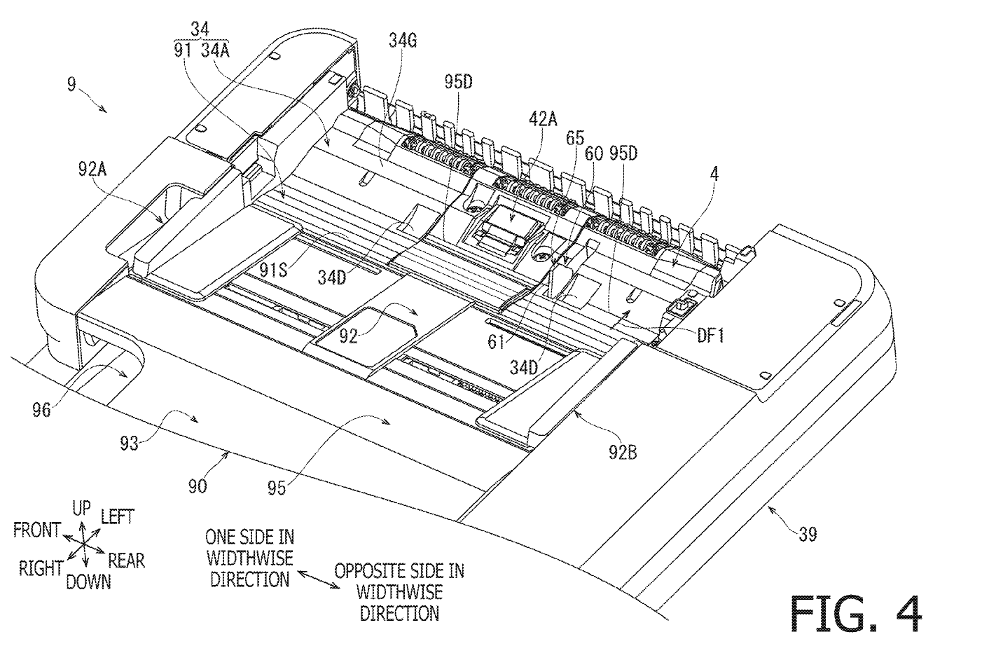

As shown in FIGS. 3 and 4, the upper chute 34 extends in the left-right direction and a widthwise direction. Although not shown, the lower chute 37 also extends in the left-right direction and the widthwise direction. Although not shown, a front end portion and a rear end portion of the upper chute 34 and a front end portion and a rear end portion of the lower chute 37 are attached to a front end portion and a rear end portion of a left-side portion of the base member 39.

The upper chute 34 integrally includes a first tray 91, which is a right-side portion of the upper chute 34, and a guide portion 34A, which is a left-side portion of the upper chute 34. The first tray 91 extends gently downward toward the left from a right end of the upper chute 34. The guide portion 34A extends gently upward toward the left and then curves downward. An upper surface of the guide portion 34A constitutes a conveying guide surface 34G.

An upper surface of the first tray 91 constitutes a first support surface 91S. The first support surface 91S is a part of the support surface 95 and includes a downstream end 95D of the support surface 95.

The cover 9 further includes a second tray 92 and a sub tray 93, which together with the first tray 91 constitute the supply tray 90. An upper surface of the second tray 92 and an upper surface of the sub tray 93 constitute a remaining portion of the support surface 95.

The supply tray 90 includes side guides 92A and 92B. The side guides 92A and 92B are arranged on the second tray 92 and are slidable in the front-rear direction. By sliding toward and away from each other, the side guides 92A and 92B position sheets SH of various sizes supported on the support surface 95 in the front-rear direction, which is a widthwise direction. In the present embodiment, the sheets SH whose images are to be read include paper of A5 to A4 sizes, postcards, and the like.

As shown in FIG. 2, the left-end upper cover 20 is swingably supported by the base member 39. The left-end upper cover 20 is swingable between a closed position shown by a solid line in FIG. 2 and an open position shown by a two-dot chain line in FIG. 2.

When the left-end upper cover 20 is in the closed position shown by the solid line in FIG. 2, the left-end upper cover 20 covers the first support surface 91S and the conveying guide surface 34G. When the left-end upper cover 20 moves to the open position shown by the two-dot chain line in FIG. 2, the left-end upper cover 20 exposes the first support surface 91S and the conveying guide surface 34G.

The lower chute 37 includes a lower guide portion 37G and a sensor accommodating portion 37H. The lower guide portion 37G is a downward-facing guide surface whose left-end side faces the scoop guide 7 from above and which extends while sloping upward toward the right. The sensor accommodating portion 37H is recessed upward from a middle portion of the lower guide portion 37G in the left-right direction and extends in a widthwise direction.

The cover 9 includes a second reading sensor 3U. The second reading sensor 3U is an example of a "reading sensor" of the present disclosure. Similar to the first reading sensor 3S, the second reading sensor 3U is a well-known image reading sensor using a contact image sensor (CIS), a charge coupled device (CCD), or the like.

The lower chute 37 supports the second reading sensor 3U in a state in which the second reading sensor 3U is accommodated in the sensor accommodating portion 37H. An opening of the sensor accommodating portion 37H that opens downward is closed by a reading glass 37R. The second reading sensor 3U is positioned below the first support surface 91S.

The cover 9 includes the conveying unit 4, a first conveying guide 31, a second conveying guide 32, and a third conveying guide 33. The conveying unit 4, the first conveying guide 31, the second conveying guide 32, and the third conveying guide 33 are located inside a left-side portion of the cover 9.

The conveying unit 4 includes a feed roller 41, a separation roller 42, a separation pad 42A, and a holder 50.

The feed roller 41 is located upstream of a downstream end 95D of the support surface 95 in the feeding direction DF1. The feed roller 41 faces the first support surface 91S from above in a state in which the feed roller 41 is covered by the left-end upper cover 20.

The separation roller 42 is located downstream of the feed roller 41 and the downstream end 95D of the support surface 95 in the feeding direction DF1. The separation roller 42 faces the conveying guide surface 34G from above. The separation roller 42 is mounted on a drive shaft 51 having a drive axis X42 that extends in the widthwise direction. The drive shaft 51 rotates about the rotational axis X42 to transmit a driving force to the separation roller 42 and thereby rotate the separation roller 42.

The separation pad 42A is swingably supported by the guide portion 34A in a state in which the separation pad 42A is exposed on the conveying guide surface 34G and faces the separation roller 42 from below. The separation pad 42A is pressed toward the separation roller 42 by a biasing spring.

As shown in FIG. 3, the holder 50 allows the drive shaft 51 to pass therethrough. Although not shown, the drive shaft 51 is supported by the left-end upper cover 20 so as to be rotatable about the rotational axis X42. Accordingly, the holder 50 is supported by the left-end upper cover 20 so as to be swingable about the rotational axis X42.

The holder 50 covers the separation roller 42 from above, from the front, and from the rear. The holder 50 extends rightward beyond the rotational axis X42, and rotatably supports the feed roller 41 at a right-end portion thereof. The holder 50 supports a gear train 41G that transmits a driving force from the drive shaft 51 to the feed roller 41.

The conveying unit 4 includes a drive source M1, a driving force transmission mechanism (not shown), a gear 4G, and a torque limiter 52.

The drive source M1 is a motor disposed on a rear side of the cover 9. The drive source M1 generates a driving force by rotating in either a forward direction or a reverse direction under control of a controller (not shown).

The driving force transmission mechanism (not shown) transmits the driving force of the drive source M1 to the gear 4G, a driving roller 43A of a first conveying roller pair 43 to be described later, a driving roller 45A of a second conveying roller pair 45, and a discharge roller 47.

The gear 4G is disposed on the rear side of the cover 9 and is located below and to the right of the rotational axis X42.

A transmission gear 51G is fixed to a rear end of the drive shaft 51. In FIG. 3, the left-end upper cover 20 in the closed position is not shown; however, when the left-end upper cover 20 is in the closed position, the transmission gear 51G meshes with the gear 4G. When the left-end upper cover 20 moves to the open position shown by the two-dot chain line in FIG. 2, the drive shaft 51, the holder 50, the separation roller 42, the feed roller 41, and the like move together with the left-end upper cover 20, and the transmission gear 51G is disengaged from the gear 4G.

As shown in FIG. 3, the torque limiter 52 is interposed between the drive shaft 51 and the holder 50. When a torque equal to or less than a preset value is applied, the torque limiter 52 transmits the torque to the holder 50. When a torque exceeding the preset value is applied, internal slipping occurs in the torque limiter 52, and the torque limiter 52 stops transmitting the torque to the holder 50.

When the left-end upper cover 20 is in the closed position, the drive shaft 51 rotates about the rotational axis X42 as a driving force transmitted from the drive source M1 is input from the gear 4G to the transmission gear 51G.

As shown in FIG. 2, when the drive source M1 rotates in the forward direction, the torque limiter 52 causes the holder 50 to follow the rotation of the drive shaft 51. As a result, the holder 50 swings so as to lower the feed roller 41. When the feed roller 41 comes into contact with an uppermost sheet SH supported on the first support surface 91S, internal slipping occurs in the torque limiter 52, thereby holding the holder 50 at that position. Consequently, the feed roller 41 presses the sheets SH supported on the support surface 95 downward.

In this case, the drive shaft 51 transmits a driving force to the separation roller 42 to rotate the separation roller 42, and also transmits a driving force to the feed roller 41 via the gear train 41G to rotate the feed roller 41. As a result, the feed roller 41 feeds an uppermost sheet SH supported on the support surface 95 in the feeding direction DF1. The separation roller 42 conveys the sheet SH fed by the feed roller 41. At this time, when a plurality of sheets SH are fed by the feed roller 41, the separation roller 42 and the separation pad 42A separate the sheets SH one by one and convey the sheets SH.

When the drive source M1 rotates in the reverse direction, the torque limiter 52 causes the holder 50 to follow the reverse rotation of the drive shaft 51. As a result, the holder 50 swings so as to raise the feed roller 41.

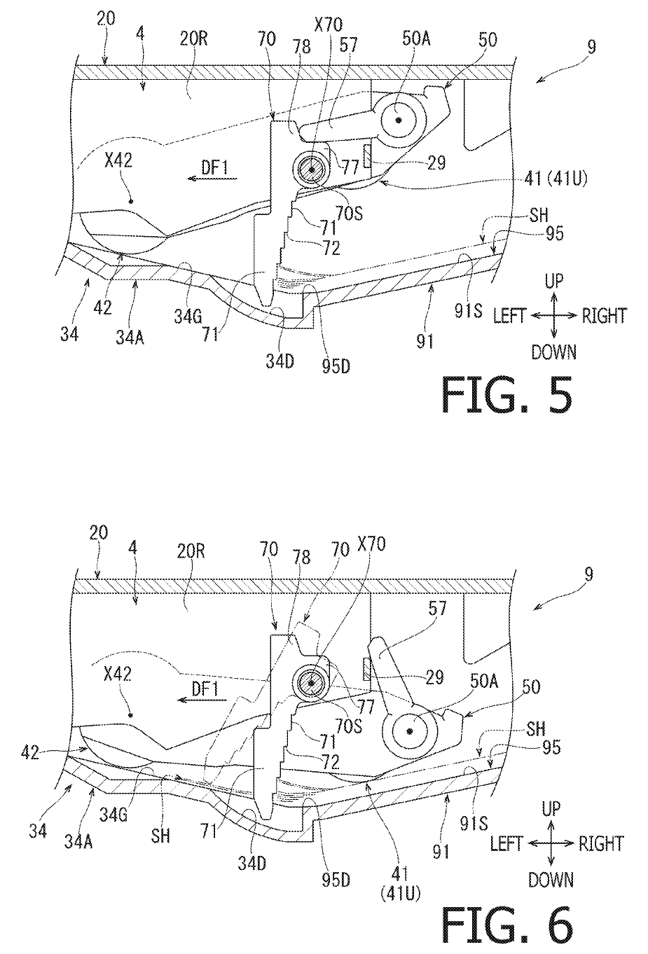

The position of the feed roller 41 (41U) shown in FIGS. 2 and 5 is an upper limit position. When the feed roller 41 reaches the upper limit position, internal slipping occurs in the torque limiter 52, thereby holding the holder 50 at that position.

At this time, since rotation of the separation roller 42 and the feed roller 41 is unnecessary, the controller (not shown) immediately stops the drive source M1 when the feed roller 41 reaches the upper limit position. The torque limiter 52 holds the holder 50 at that position even after the drive source M1 is stopped.

As shown in FIG. 2, the conveying unit 4 includes a first conveying roller pair 43, a first pressing member 44, a second pressing member 46, a second conveying roller pair 45, a discharge roller 47, and an elastic piece 48.

The first conveying roller pair 43 is located on a side wall side on the left side of the cover 9 and on a side close to an upper surface of the main body 8. The first pressing member 44 is located directly above the reading surface 3B. The first pressing member 44 extends in the widthwise direction at a position directly above the reading surface 3B and to the left of the lower guide portion 37G. The first pressing member 44 is biased toward the reading surface 3B by a biasing spring.

The first conveying guide 31 includes the conveying guide surface 34G and a plurality of ribs 20R that protrude downward from an inner surface of the left-end upper cover 20, and the like. The first conveying guide 31 guides sheets SH supported on the support surface 95 leftward via the separation roller 42, then turns the sheets SH downward in a U-turn, and guides the sheets SH to the first conveying roller pair 43.

The second conveying guide 32 includes a portion of the lower chute 37 that is located to the left of the first pressing member 44, guide surfaces formed inside a left side surface portion of the cover 9, and the like.

The second conveying guide 32 guides the sheet SH so as to slope downward from the first conveying roller pair 43 toward the reading surface 3B, and then guides the sheet SH so as to pass between the first pressing member 44 and the reading surface 3B, that is, above the first reading sensor 3S in the stationary reading position. The first pressing member 44 presses the sheet SH passing over the reading surface 3B toward the reading surface 3B.

The second pressing member 46 is held at a portion of the base frame 39 that faces the reading glass 37R from below. The second pressing member 46 extends in the widthwise direction at a position to the right of the scoop guide 7 and below the second reading sensor 3U. The second pressing member 46 is biased toward the reading glass 37R and the second reading sensor 3U by a biasing spring.

The second conveying roller pair 45 is located at a position that is spaced upward and leftward from a left end of the discharge tray 96. The discharge roller 47 is located at a position spaced upward from the left end of the discharge tray 96 and slightly offset leftward from the same left end. An upper end of the discharge roller 47 is positioned higher than a nip position of the second conveying roller pair 45.

The elastic piece 48 is made of a high-rigidity film. The elastic piece 48 is cantilevered at a right end of the lower guide portion 37G and protrudes rightward, and is bent at a position to the right of the discharge roller 47 so as to slope downward toward the right.

In the present embodiment, the conveying unit 4 includes a plurality of discharge rollers 47 and a plurality of elastic pieces 48 arranged alternately in the widthwise direction. For ease of illustration, FIG. 2 shows one discharge roller 47 and one elastic piece 48, while the actual conveying unit 4 is provided with the plurality of discharge rollers 47 and the plurality of elastic pieces 48 in the widthwise direction.

The third conveying guide 33 includes a lower surface of the lower guide portion 37G, a lower surface of the reading glass 37R, the scoop guide 7, a portion of the base frame 39 that is located between the scoop guide 7 and the second pressing member 46 and faces the lower guide portion 37G from below, the second pressing member 46, and a portion of the base frame 39 that is located between the second pressing member 46 and the discharge tray 96 and faces the lower guide portion 37G from below, and the like.

The third conveying guide 33 is configured to scoop up a sheet SH passing over the reading surface 3B by the scoop guide 7 and to guide the sheet SH so as to pass between the second pressing member 46 and the reading glass 37R, that is, below the second reading sensor 3U. The second pressing member 46 presses the sheet SH scooped up by the scoop guide 7 toward the reading glass 37R and the second reading sensor 3U. The third conveying guide 33 then guides the sheet SH to pass through the second conveying roller pair 45 and further guides the sheet SH to the discharge roller 47 and the elastic piece 48.

The cover 9 has a conveying path P1 defined by the first to third conveying guides 31 to 33. The conveying path P1 extends leftward from the supply tray 90, then makes a downward U-turn to change its direction, and thereafter passes below the support surface 95 and extends to the discharge tray 96.

The conveying unit 4 conveys the sheet SH fed by the feed roller 41 so as to make a downward U-turn along the conveying path P1, causes the sheet SH to pass below an actuator 60 to be described later, and further conveys the sheet SH so as to pass below the support surface 95.

As shown in FIG. 3, the conveying unit 4 includes two (i.e., front and rear) lock members 57. The front lock member 57 is swingably supported on a support shaft 50A that protrudes forward from a front-right corner portion of the holder 50. The rear lock member 57 is swingably supported on a support shaft 50B that protrudes rearward from a rear-right corner portion of the holder 50. Each lock member 57 protrudes in a radially outward direction of the corresponding support shaft 50A or 50B.

In FIGS. 5 and 6, the front lock member 57 is illustrated, and illustration of the rear lock member 57 is omitted because the rear lock member 57 is the same as the front lock member 57.

As shown in FIGS. 5 and 6, the left-end upper cover 20 includes two (i.e., front and rear) lock release ribs 29. In FIGS. 5 and 6, the front lock release rib 29 is illustrated, and illustration of the rear lock release rib 29 is omitted because the rear lock release rib 29 is the same as the front lock release rib 29.

The front lock release rib 29 is formed between two ribs 20R that position the front lock member 57 therebetween. The rear lock release rib 29 is formed between two ribs 20R that position the rear lock member 57 therebetween.

Each lock release rib 29 extends in the front-rear direction at a position spaced leftward and downward from the corresponding support shaft 50A or 50B.

As shown in FIG. 5, when the holder 50 is in a state in which the feed roller 41 has been raised to the upper limit position, each lock member 57 is in a lock position in which the lock member 57 protrudes leftward at a position above the corresponding lock release rib 29.

As shown in FIG. 6, when the holder 50 lowers the feed roller 41 from the upper limit position, each lock member 57 comes into contact with the corresponding lock release rib 29, swings upward, and moves to an unlock position.

That is, each lock member 57 is in the lock position until the feed roller 41 feeds a sheet SH, and moves to the unlock position when the feed roller 41 is lowered to feed the sheet SH.

As shown in FIG. 5, each lock member 57 returns to the lock position when the holder 50 returns the feed roller 41 to the upper limit position.

As shown in FIG. 3, the conveying unit 4 includes two (i.e., front and rear) shutters 70. The front shutter 70 is located to the left of the front lock member 57 and the support shaft 50A. The rear shutter 70 is located to the left of the rear lock member 57 and the support shaft 50B.

In FIGS. 5 and 6, the front shutter 70 is illustrated, and illustration of the rear shutter 70 is omitted because the rear shutter 70 is the same as the front shutter 70.

The front shutter 70 is supported by a support shaft 70S mounted on two ribs 20R that position the front lock member 57 therebetween so as to be rotatable about a swing axis X70. The rear shutter 70 is supported by a support shaft 70S mounted on two ribs 20R that position the rear lock member 57 therebetween so as to be rotatable about the swing axis X70.

The swing axis X70 extends in the widthwise direction at a position spaced leftward from each lock release rib 29 and slightly offset downward from each lock release rib 29. The swing axis X70 is located substantially directly above the downstream end 95D of the support surface 95. Although not shown, the swing axis X70 is positioned above an uppermost sheet SH when a maximum number of sheets SH are supported on the support surface 95.

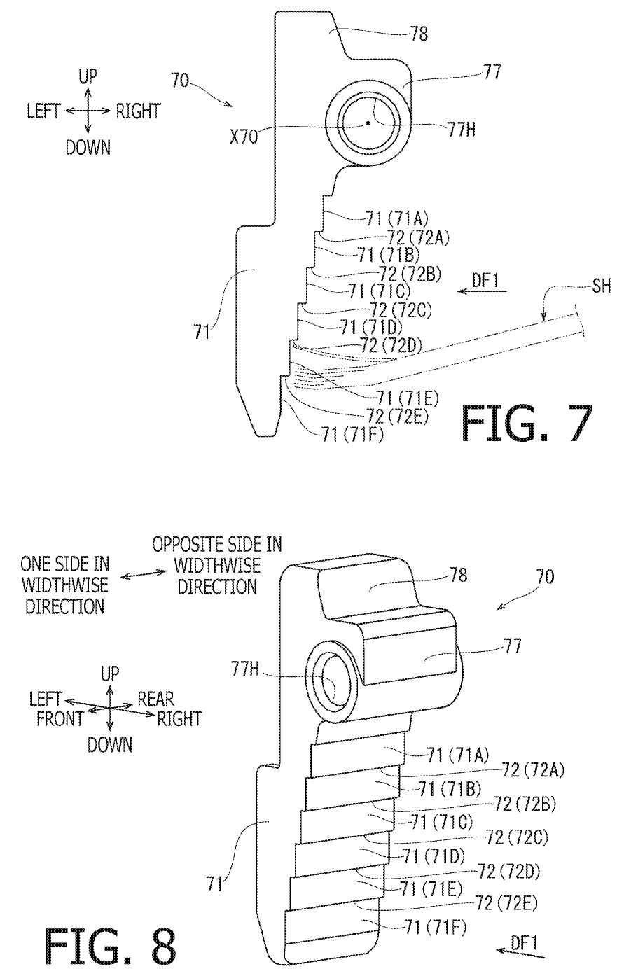

As shown in FIGS. 7 and 8, each shutter 70 integrally includes a shaft-supported portion 77, a shutter body 71, and a lock receiving portion 78. In the present embodiment, each shutter 70 is a resin molded product and is manufactured by injection molding of a thermoplastic resin or by another suitable molding method using a thermoplastic resin.

The shaft-supported portion 77 has a substantially block-like shape. The shaft-supported portion 77 is formed with a through hole 77H that penetrates in the widthwise direction. The through hole 77H is a circular hole centered on the swing axis X70, and the support shaft 70S is inserted into the through hole 77H.

The shutter body 71 is connected to a portion of a lower surface of the shaft-supported portion 77 that is located to the left of the through hole 77H, and protrudes downward therefrom.

The lock receiving portion 78 is connected to a portion of an upper surface of the shaft-supported portion 77 that is located to the left of the through hole 77H, and protrudes upward by a short length therefrom.

As shown in FIG. 4, two recesses 34D are formed so as to be recessed downward in the conveying guide surface 34G on a side of the downstream end 95D of the support surface 95.

As shown in FIG. 5, the shutter body 71 of each shutter 70 protrudes downward, with a lower end thereof entering the corresponding recess 34D. The position of each shutter 70 shown in FIG. 5 and the position of each shutter 70 shown by the solid line in FIG. 6 are regulation positions at which a leading edge of a sheet SH inserted along the support surface 95 is regulated.

As shown by the two-dot chain line in FIG. 6, the shutter body 71 of each shutter 70 swings such that a lower end thereof moves leftward, thereby separating the lower end upward from the corresponding recess 34D and the conveying guide surface 34G. The position of each shutter 70 shown by the two-dot chain line in FIG. 6 is a retracted position in which the shutter 70 is retracted from (i.e., the shutter 70 does not interfere with sheet conveyance of) a sheet SH fed by the feed roller 41.

That is, each shutter 70 is configured to swing about the swing axis X70 between the regulation position and the retracted position.

As shown in FIG. 5, when the holder 50 is in a state in which the feed roller 41 has been raised to the upper limit position, each lock member 57 in the lock position brings a distal end thereof into contact with the corresponding lock receiving portion 78, thereby restricting swinging of each shutter 70 from the regulation position to the retracted position.

As shown in FIG. 6, when the holder 50 lowers the feed roller 41 from the upper limit position, each lock member 57 swings to the unlock position, thereby separating a distal end thereof from the corresponding lock receiving portion 78 and allowing each shutter 70 to swing from the regulation position to the retracted position.

The shutter 70 shown in FIGS. 7 and 8 is defined with reference to an attitude when the shutter 70 is in the regulation position as regulated by each lock member 57 in the lock position. The shutter 70 has six first regulation surfaces 71 (71A, 71B, 71C, 71D, 71E, and 71F) and five second regulation surfaces 72 (72A, 72B, 72C, 72D, and 72E).

Each of the first regulation surfaces 71 (71A to 71F) is a flat surface arranged in an up-down direction and facing rightward, that is, upstream in the feeding direction DF1. When each shutter 70 is regulated by the corresponding lock member 57 in the lock position, the first regulation surfaces 71 (71A to 71F) extend along a vertical direction. In the present embodiment, the first regulation surfaces 71 (71A to 71F) extend parallel to the vertical direction.

Each of the second regulation surfaces 72 (72A to 72E) is a flat surface that is located between the first regulation surfaces 71 (71A to 71F) and faces downward. When each shutter 70 is regulated by the corresponding lock member 57 in the lock position, the second regulation surfaces 72 (72A to 72E) extend along a horizontal direction. In the present embodiment, the second regulation surfaces 72 (72A to 72E) extend parallel to the horizontal direction.

When two first regulation surfaces 71 that are adjacent to each other in the up-down direction are considered, an upper one is defined as a first surface and the other is defined as a second surface. The entirety of the second surface is located to the left of the first surface, that is, downstream in the feeding direction DF1. A second regulation surface 72 located between the first surface and the second surface is connected to a lower end of the first surface and an upper end of the second surface.

Specifically, the first regulation surface 71B as a whole is located to the left of the first regulation surface 71A, and the second regulation surface 72A located between the first regulation surfaces 71A and 71B is connected to a lower end of the first regulation surface 71A and an upper end of the first regulation surface 71B.

The first regulation surface 71C as a whole is located to the left of the first regulation surface 71B, and the second regulation surface 72B located between the first regulation surfaces 71B and 71C is connected to a lower end of the first regulation surface 71B and an upper end of the first regulation surface 71C.

The first regulation surface 71D as a whole is located to the left of the first regulation surface 71C, and the second regulation surface 72C located between the first regulation surfaces 71C and 71D is connected to a lower end of the first regulation surface 71C and an upper end of the first regulation surface 71D.

The first regulation surface 71E as a whle is located to the left of the first regulation surface 71D, and the second regulation surface 72D located between the first regulation surfaces 71D and 71E is connected to a lower end of the first regulation surface 71D and an upper end of the first regulation surface 71E.

The first regulation surface 71F as a whole is located to the left of the first regulation surface 71E, and the second regulation surface 72E located between the first regulation surfaces 71E and 71F is connected to a lower end of the first regulation surface 71E and an upper end of the first regulation surface 71F.

As shown in FIGS. 5 and 7, when each shutter 70 is in the regulation position, each of the first regulation surfaces 71 (71A to 71F) and each of the second regulation surfaces 72 (72A to 72E) is capable of coming into contact with a leading edge of a sheet SH inserted by a user along the support surface 95.

Thereafter, when the feed roller 41 feeds the sheet SH supported on the support surface 95, as shown by the two-dot chain line in FIG. 6, each shutter 70 is pushed by the fed sheet SH via the first regulation surfaces 71 (71A to 71F) and the second regulation surfaces 72 (72A to 72E), thereby swinging to the retracted position and allowing the sheet SH to pass therethrough.

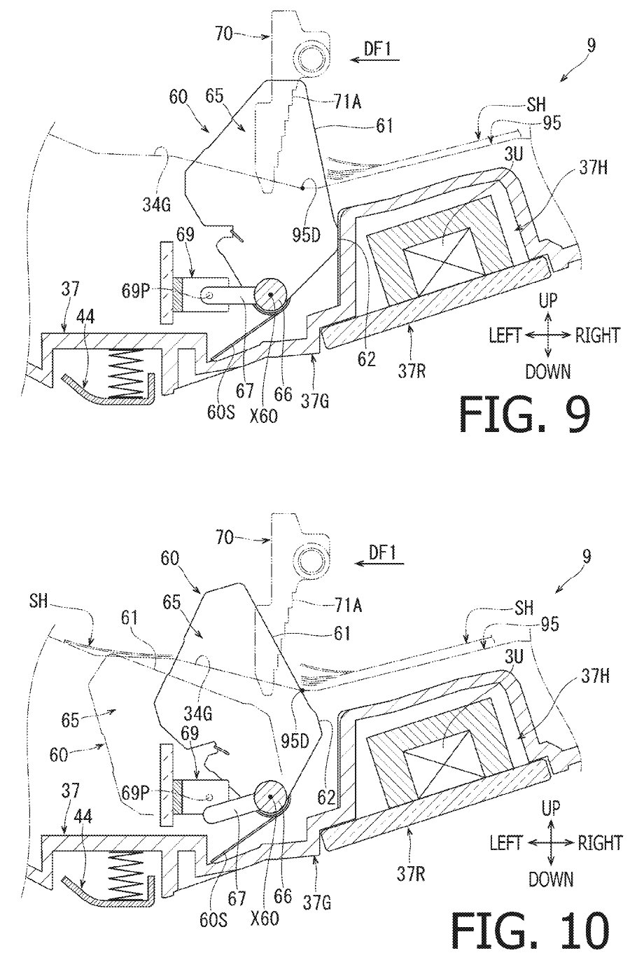

The shutter 70 shown in FIGS. 9 and 10 is in the regulation position as regulated by each lock member 57 in the lock position.

As shown in FIGS. 9 and 10, the cover 9 includes an actuator 60 and a sensor 69 for detecting presence or absence of a sheet SH supported on the support surface 95.

As shown in FIG. 9, the actuator 60 includes an actuator body 65, a swing shaft 66, and a shielding portion 67. In the present embodiment, the actuator 60 is a resin molded product in which the actuator body 65, the swing shaft 66, and the shielding portion 67 are integrally formed, and is manufactured by injection molding of a thermoplastic resin or by another suitable molding method using a thermoplastic resin.

The actuator body 65 has a flat plate shape extending in an up-down direction and a left-right direction. The swing shaft 66 is connected to a lower end of the actuator body 65 and extends in the widthwise direction about a swing axis X60. The shielding portion 67 is a plate-shaped piece that protrudes leftward from the swing shaft 66.

The swing axis X60 is located downstream of the downstream end 95D of the support surface 95 in the feeding direction DF1. That is, the swing axis X60 is located downstream of the feed roller 41 in the feeding direction DF1. The swing axis X60 is located below the support surface 95 and above the lower guide portion 37G of the lower chute 37. The swing axis X60 is located, in the left-right direction, between the first pressing member 44 and the sensor accommodating portion 37H.

Although not shown, the swing shaft 66 is swingably supported by the lower chute 37, so that the actuator 60 is configured to swing about the swing axis X60.

The sensor 69 is located in the vicinity of the shielding portion 67. The sensor 69 is a photointerrupter having an optical path 69P extending from a light-emitting portion (not shown) to a light-receiving portion. The sensor 69 is configured to detect blocking and opening of the optical path 69P by the shielding portion 67 of the actuator 60. The sensor 69 is configured to transmit a detection signal corresponding to the blocking and opening of the optical path 69P to the controller (not shown).

The actuator 60 is biased by a torsion coil spring 60S in a clockwise direction as viewed in FIG. 9. The actuator body 65 includes a stopper 62 and a contact surface 61.

The stopper 62 is a rightward-facing end surface formed on the actuator body 65 at a position spaced rightward and upward from the swing shaft 66. When the stopper 62 comes into contact with a left wall of the sensor accommodating portion 37H due to a biasing force of the torsion coil spring 60S, an initial position of the actuator 60 is determined. In this state, the shielding portion 67 blocks the optical path 69P.

The contact surface 61 is a forward-facing end surface formed on the actuator body 65 at a position above the stopper 62. The contact surface 61 is inclined such that the contact surface 61 is shifted leftward as the contact surface 61 extends upward, and extends to an upper end of the actuator body 65.

As shown in FIG. 4, when the actuator 60 is in the initial position, an upper portion of the actuator body 65 protrudes upward from the upper chute 34 at a position slightly spaced forward from the rear recess 34D.

As shown in FIG. 9, when the actuator 60 is in the initial position, the contact surface 61 is located upstream of the downstream end 95D of the support surface 95 in the feeding direction DF1. The contact surface 61 is capable of coming into contact with a leading edge of a sheet SH inserted along the support surface 95. The initial position of the actuator 60 is a position in which the contact surface 61 is not in contact with the leading edge of the sheet SH inserted along the support surface 95.

When the contact surface 61 is not in contact with the leading edge of the sheet SH inserted along the support surface 95, the contact surface 61 is located upstream of the uppermost first regulation surface 71A of each shutter 70 that is in the regulation position in the feeding direction DF1.

As shown by the solid line in FIG. 10, when the contact surface 61 comes into contact with the leading edge of the sheet SH inserted along the support surface 95, the contact surface 61 is pushed leftward and swings. As a result, in a state after the contact surface 61 has swung while being in contact with the leading edge of the sheet SH inserted along the support surface 95, the contact surface 61 is located downstream of the uppermost first regulation surface 71A of each shutter 70 that is in the regulation position in the feeding direction DF1. Further, the shielding portion 67 opens the optical path 69P.

As shown by the two-dot chain line in FIG. 10, when the contact surface 61 is pushed by the sheet SH fed by the feed roller 41, the actuator 60 further swings counterclockwise in FIG. 10.

As shown in FIG. 9, when the shielding portion 67 blocks the optical path 69P, the sensor 69 detects absence of a sheet SH supported on the support surface 95 based on the actuator 60 being in the initial position.

As shown in FIG. 10, when the shielding portion 67 opens the optical path 69P, the sensor 69 detects presence of a sheet SH supported on the support surface 95 based on the actuator 60 having swung from the initial position.

When the image reading unit 3 reads an image of a sheet SH supported on the support surface 95, the controller (not shown) that has received a start instruction for the image reading operation determines presence or absence of the sheet SH supported on the support surface 95 based on a detection signal transmitted from the sensor 69.

When the controller (not shown) determines that no sheet SH is supported on the support surface 95, the controller displays, on a display screen of the operation panel 8P, a message indicating that no sheet SH is present on the support surface 95, and waits until a sheet SH is supported on the support surface 95.

When the controller (not shown) determines that a sheet SH is supported on the support surface 95, the control unit causes the drive source M1 to rotate in a forward direction to operate the conveying unit 4.

The conveying unit 4 rotationally drives the feed roller 41 and the separation roller 42 in a clockwise direction as viewed in FIG. 2, rotationally drives the driving roller 43A of the first conveying roller pair 43 and the driving roller 45A of the second conveying roller pair 45 in a counterclockwise direction as viewed in FIG. 2, and rotationally drives the discharge roller 47 in a clockwise direction as viewed in FIG. 2.

As a result, as shown in FIG. 6, the holder 50 swings so as to lower the feed roller 41 (41U) that is at the upper limit position, and the feed roller 41 comes into contact with an uppermost sheet SH supported on the support surface 95. At this time, the feed roller 41 presses the uppermost sheet SH supported on the support surface 95 downward. In addition, each lock member 57 swings to the unlock position, thereby allowing each shutter 70 to swing from the regulation position to the retracted position.

As shown in FIG. 2, the feed roller 41 feeds the uppermost sheet SH supported on the support surface 95 in the feeding direction DF1. When a plurality of sheets SH are fed by the feed roller 41, the separation roller 42 and the separation pad 42A separate the sheets SH one by one and convey the sheets SH toward the first conveying roller pair 43.

Next, the first conveying roller pair 43 conveys the sheet SH guided by the first conveying guide 31 and the second conveying guide 32, and causes the sheet SH to pass above the first reading sensor 3S located at the stationary reading position. The first reading sensor 3S reads an image of a downward-facing surface of the sheet SH passing over the reading surface 3B. The downward-facing surface of the sheet SH passing over the reading surface 3B corresponds to a surface that faced upward when the sheet SH was supported on the support surface 95.

Further, the first conveying roller pair 43 conveys the sheet SH toward the second reading sensor 3U. When the image reading unit 3 reads images on both surfaces of the sheet SH, the second reading sensor 3U reads an image of an upward-facing surface of the sheet SH scooped up by the scoop guide 7. The upward-facing surface of the sheet SH scooped up by the scoop guide 7 corresponds to a surface that faced downward when the sheet SH was supported on the support surface 95.

In other words, the second reading sensor 3U reads an image of an upward-facing surface of the sheet SH that, after making a U-turn along the conveying path P1, advances toward the discharge tray 96.

The second conveying roller pair 45 then conveys the sheet SH, which is guided by the third conveying guide 33, toward the discharge roller 47 and the elastic piece 48. The discharge roller 47 and the elastic piece 48 discharge the sheet SH onto the discharge tray 96 while deforming the sheet SH into a wave shape.

At this time, the discharge roller 47 and the elastic piece 48 discharge the sheet SH onto the discharge tray 96 from a position higher than a nip position of the second conveying roller pair 45.

When image reading of the sheet SH is completed, the controller (not shown) causes the drive source M1 to rotate in a reverse direction for a short period of time. As a result, as shown in FIG. 5, the holder 50 swings so as to raise the feed roller 41 to the upper limit position. In addition, each lock member 57 swings to the lock position, and a distal end thereof comes into contact with the corresponding lock receiving portion 78, thereby restricting swinging of each shutter 70 from the regulation position to the retracted position.

In the image reading apparatus 1 of the present embodiment, as shown in FIGS. 7 and 8, of two first regulation surfaces 71 that are adjacent to each other in the up-down direction, when an upper one is defined as a first surface and the other is defined as a second surface, an entirety of the second surface is located downstream of the first surface in the feeding direction DF1, and a second regulation surface 72 located between the first surface and the second surface is connected to a lower end of the first surface and an upper end of the second surface. This relationship means that the first regulation surfaces 71 (71A to 71F) and the second regulation surfaces 72 (72A to 72E) form a stepped inclination, and that the stepped inclination extends such that the stepped inclination is shifted downstream in the feeding direction DF1 as the stepped inclination approaches the support surface 95.

With this configuration, as shown in FIGS. 5 and 7, each of the first regulation surfaces 71 (71A to 71F) can effectively regulate a leading edge of a sheet SH inserted along the support surface 95 while guiding the leading edge downward so as to approach the support surface 95, regardless of whether or not the leading edge of the sheet SH is curled upward.

In addition, when a sheet SH having a leading edge curled upward is inserted along the support surface 95, each of the second regulation surfaces 72 (72A to 72E) comes into contact with the leading edge of the sheet SH and prevents the leading edge from moving upward.

Therefore, the image reading apparatus 1 of the present embodiment can effectively align a leading edge of a sheet SH even when a sheet SH having a leading edge curled upward is inserted along the support surface 95.

Further, in the image reading apparatus 1, as shown in FIG. 9, when the contact surface 61 of the actuator 60 is not in contact with a leading edge of a sheet SH inserted along the support surface 95, the contact surface 61 is located upstream of the uppermost first regulation surface 71A of each shutter 70 that is in the regulation position in the feeding direction DF1. As shown by the solid line in FIG. 10, after the contact surface 61 comes into contact with the leading edge of the sheet SH inserted along the support surface 95, the actuator 60 is swung by the sheet SH, and in this swung state, the contact surface 61 is located downstream of the uppermost first regulation surface 71A of each shutter 70 that is in the regulation position in the feeding direction DF1. Then, as shown by the two-dot chain line in FIG. 10, when the contact surface 61 is pushed by the sheet SH fed by the feed roller 41, the actuator 60 is further swung by the sheet SH to a position that does not interfere with advancement of the sheet SH. With this configuration, even when a sheet SH having a leading edge curled upward is inserted along the support surface 95, effects of the first regulation surfaces 71 (71A to 71F) and the second regulation surfaces 72 (72A to 72E) of each shutter 70 can suppress the leading edge of the sheet SH from lifting along the contact surface 61 of the actuator 60 that swings. As a result, the actuator 60 can be pushed by the sheet SH and swing reliably, and consequently, the sensor 69 can accurately detect presence or absence of a sheet SH supported on the support surface 95.

Further, in the image reading apparatus 1, as shown in FIG. 2, the conveying unit 4 conveys a sheet SH fed by the feed roller 41 such that the sheet SH makes a downward U-turn, passes below the actuator 60, and further passes below the support surface 95. The second reading sensor 3U is located below the first support surface 91S and reads an image of an upward-facing surface of the sheet SH after the U-turn.

With this configuration, although a layout of each shutter 70 and the actuator 60 is greatly constrained by the second reading sensor 3U, effects of the first regulation surfaces 71 (71A to 71F) and the second regulation surfaces 72 (72A to 72E) of each shutter 70 allow the actuator 60 to reliably swing when pushed by a sheet SH inserted along the support surface 95. As a result, the sensor 69 can accurately detect presence or absence of a sheet SH supported on the support surface 95.

Further, in the image reading apparatus 1, as shown in FIG. 5, each lock member 57 remains in the lock position until the feed roller 41 feeds a sheet SH, and as shown in FIG. 6, each lock member 57 swings to the unlock position when the feed roller 41 feeds the sheet SH. With this configuration, until the feed roller 41 feeds the sheet SH, each shutter 70 is reliably maintained in the regulation position by the corresponding lock member 57. As a result, each shutter 70 can effectively align a leading edge of a sheet SH inserted along the support surface 95.

Further, in the image reading apparatus 1, as shown in FIG. 7, when each shutter 70 is regulated by the corresponding lock member 57 in the lock position, each of the first regulation surfaces 71 (71A to 71F) extends along the vertical direction. With this configuration, each shutter 70 can more effectively align a leading edge of a sheet SH inserted along the support surface 95.

While aspects of the present disclosure have been described in conjunction with various example structures outlined above and illustrated in the figures, various alternatives, modifications, variations, improvements, and/or substantial equivalents, whether known or that may become apparent to those having at least ordinary skill in the art, may be adopted. Accordingly, the example embodiments described above are intended to be illustrative of aspects of the present disclosure and are not intended to limit the present disclosure. Various changes may be made without departing from the spirit and scope of the present disclosure. Therefore, the present disclosure is intended to embrace all known or later developed alternatives, modifications, variations, improvements, and/or substantial equivalents. Some specific examples of potential alternatives, modifications, or variations applicable to the described aspects are provided below.

In the embodiment described above, the sheet feeding device according to the present disclosure is implemented as the image reading apparatus 1 having both an image forming function and an image reading function. However, the present disclosure is not limited to this configuration. For example, the configuration of the present disclosure may be applied to an image reading apparatus having only an image reading function, or may be applied to an image forming apparatus having only an image forming function.

In the embodiment described above, when each shutter 70 is regulated by the corresponding lock member 57 in the lock position, each of the first regulation surfaces 71 extends parallel to the vertical direction. However, the present disclosure is not limited to this configuration. For example, a configuration in which, when each shutter is regulated by the corresponding lock member in the lock position, each first regulation surface extends so as to intersect the vertical direction at an angle of several degrees or less is also included in the present disclosure.

What is claimed is:

1. A sheet feeding device comprising:
a supply tray having a support surface configured to support a sheet;
a feed roller configured to feed the sheet supported on the support surface in a feeding direction orthogonal to a widthwise direction of the support surface; and
a shutter configured to swing between a regulation position and a retracted position,
wherein, when in the regulation position, the shutter regulates a leading edge of a sheet inserted along the support surface,
wherein, when in the retracted position, the shutter does not interfere with advancement of a sheet,
wherein the shutter has a plurality of first regulation surfaces and at least one second regulation surface, the plurality of first regulation surfaces and the at least one second regulation surface being capable of coming into contact with the leading edge of the sheet when the shutter is located at the regulation position,
wherein each of the first regulation surfaces is arranged in an up-down direction and faces upstream in the feeding direction,
wherein the second regulation surface is located between the first regulation surfaces and faces downward,
wherein, when two first regulation surfaces are adjacent to each other in the up-down direction, an upper one of the two first regulation surfaces is defined as a first surface and the other is defined as a second surface,
wherein an entirety of the second surface is located downstream of the first surface in the feeding direction, and
wherein the second regulation surface located between the first surface and the second surface is connected to a lower end of the first surface and an upper end of the second surface.

2. The sheet feeding device according to claim 1, further comprising:
an actuator swingable about a swing axis extending in the widthwise direction and located downstream of the feed roller in the feeding direction and below the support surface, the actuator having a contact surface configured to come into contact with the leading edge of the sheet inserted along the support surface; and
a sensor configured to detect presence or absence of a sheet supported on the support surface based on a position of the actuator,
wherein, when the contact surface is not in contact with the leading edge of the sheet inserted along the support surface, the contact surface is located upstream of an uppermost first regulation surface of the shutter that is in the regulation position in the feeding direction,
wherein, when the contact surface has come into contact with the leading edge of the sheet inserted along the support surface, the contact surface is located downstream of the uppermost first regulation surface of the shutter that is in the regulation position in the feeding direction, and
wherein, when the contact surface is pushed by the sheet fed by the feed roller, the actuator further swings to a position where advancement of the sheet is allowed.

3. The sheet feeding device according to claim 2, further comprising:
a conveying unit configured to convey a sheet fed by the feed roller such that the sheet makes a downward U-turn, passes below the actuator, and further passes below the support surface; and
a reading sensor located below the support surface and configured to read an image of an upward-facing surface of the sheet after the U-turn.

4. The sheet feeding device according to claim 1,
further comprising a lock member movable between a lock position that restricts swinging of the shutter from the regulation position to the retracted position and an unlock position that allows swinging of the shutter from the regulation position to the retracted position,
wherein the lock member is in the lock position until the feed roller feeds a sheet, and switches to the unlock position when the feed roller feeds the sheet.

5. The sheet feeding device according to claim 4,
wherein the lock member is configured to move between the lock position and the unlock position in synchronization with a feeding operation of the feed roller,
wherein the lock member is maintained in the lock position before the feeding operation starts, and
wherein the lock member is released to the unlock position during the feeding operation so as to permit movement of the shutter to the retracted position.

6. The sheet feeding device according to claim 4,
wherein, when the shutter is regulated by the lock member in the lock position, each of the first regulation surfaces extends along a vertical direction.

7. A sheet feeding device comprising:
a support surface configured to support a sheet; and a regulating member configured to regulate a leading edge of a sheet inserted along the support surface,
wherein the regulating member includes a plurality of first regulation surfaces arranged in an up-down direction and facing upstream in a feeding direction, and at least one second regulation surface facing downward and located between adjacent first regulation surfaces, and of two first regulation surfaces adjacent in the up-down direction, an entirety of a lower first regulation surface is located downstream of an upper first regulation surface in the feeding direction.

8. The sheet feeding device according to claim 7,
wherein the second regulation surface connects a lower end of the upper first regulation surface and an upper end of the lower first regulation surface.

9. The sheet feeding device according to claim 7,
wherein the first regulation surfaces extend along a vertical direction.

10. The sheet feeding device according to claim 7,
wherein the regulating member is configured to regulate a leading edge of a sheet having a leading edge curled upward.

11. The sheet feeding device according to claim 7,
wherein the regulating member is swingable between a regulation position for regulating the leading edge of the sheet and a retracted position retracted from a sheet being fed.
